(19) United States
(12) Patent Application Publication
(10) Pub. No.: US 2015/0343525 A1
(43) Pub. Date: Dec. 3, 2015

(54) METHOD FOR CENTRIFUGAL CASTING OF MOTOR ROTOR

(71) Applicant: HYUNDAI HEAVY INDUSTRIES CO., LTD, Ulsan (KR)

(72) Inventors: Sung-Mo LEE, Ulsan (KR); Kwang-Jin HAN, Ulsan (KR); Ji-Hoon YOO, Pohang-si (KR); Jong-Wook LIM, Ulsan (KR); Young-Cheol YOON, Ulsan (KR)

(73) Assignee: HYUNDAI HEAVY INDUSTRIES CO., LTD, Ulsan (KR)

(21) Appl. No.: 14/291,469

(22) Filed: May 30, 2014

(51) Int. Cl. B22D 13/10; H02K 15/02; B22D 13/04

(52) U.S. Cl. CPC B22D 13/10; B22D 13/04; H02K 15/02

(57) ABSTRACT

Disclosed herein is a method for centrifugal casting of a motor rotor. The method includes: assembling molds and a core; heating the assembled mold and core to a preset temperature; and forming a motor core by injecting molten metal into a forming space inside the mold and the core while rotating the assembled mold.

### BACKGROUND

1. Technical Field

The present invention relates to a method for centrifugal casting of a motor rotor, and more particularly, to a method of centrifugally casting of a motor rotor which has less shrinkage, fewer pores and high density.

2. Description of the Related Art

In general, a motor or an induction motor includes a rotor rotating at the center thereof and a stator formed around the rotor.

The rotor is formed at a center thereof with a hole into which a shaft is inserted, and includes a rotor core, which is constituted by a plurality of thin silicon steel plates stacked one above another.

The rotor is formed with a plurality of slots penetrating the rotor core and having an arc shape, and is provided at both ends thereof with end rings, which electrically connect distal ends of a bar of the rotor to form a circuit.

In the related art, rotors for small motors used in home appliances have been produced through centrifugal casting after securing such a core to an inner side of a mold and injecting molten metal into the mold, and die-casting has been used for large scale industrial products. Die-casting has problems such as many pores, severe shrinkage, and non-dense structure due to injection of molten metal at high speed to prevent coagulation of the molten metal.

Particularly, in a conventional centrifugal casting method applied to a motor rotor for small home appliances, molds are rotated after only an upper mold and a lower mold are preheated by a torch.

However, the conventional centrifugal casting method has been restrictively applicable to only the small motor rotor since only the upper and lower molds are preheated and thus the molten metal has low fluidity within the molds due to difference in temperature between the molten metal and the core when the molten metal is injected into the molds in practice.

As a result, there is a problem of incomplete forming of the rotor.

Moreover, in the conventional centrifugal casting method, since the upper and lower molds are preheated by the torch and then assembled with the core, safety accident frequently occur in operation.

### BRIEF SUMMARY

It is an aspect of the present invention to provide a method for centrifugal casting of a motor rotor, in which centrifugal casting is performed after an upper mold, a lower mold and a core are pre-assembled and then heated, thereby preventing incomplete forming of the rotor while improving fluidity of molten metal and workability.

In accordance with one aspect of the present invention, a method for centrifugal casting of a motor rotor includes: assembling molds and a core; heating the assembled mold and core to a preset temperature; and forming a motor core by injecting molten metal into a forming space inside the mold and the core while rotating the assembled mold.

The mold may include upper and lower molds.

Assembling the mold and the core may include preparing the lower mold; securing the core to the lower mold; and assembling the upper mold and the lower mold to form the forming space.

The upper mold, the lower mold and the core may be uniformly heated to a predetermined temperature after being assembled and secured to each other.

Formation of the motor core may include placing the mold and the core on a rotary table; and injecting the molten metal through a molten metal injection port formed in the upper mold to communicate with the forming space to fill the forming space inside the mold and the core with the molten metal.

According to the present invention, the upper mold, the lower mold and the core are previously assembled and heated to perform centrifugal casting, thereby improving fluidity of molten metal injected into the assembled mold.

In addition, the method according to the present invention can reduce difference in temperature between the molten metal and the molds/core, thereby preventing incomplete forming while improving product quality.

Further, the molds and the core are preassembled and then heated, thereby ensuring operator safety while improving workability.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a flowchart of a method for centrifugal casting of a motor rotor in accordance with one embodiment of the present invention;

FIG. 2 is a view showing a process of preparing a lower mold in accordance with one embodiment of the present invention;

FIG. 3a is a view showing a process of assembling a core into the lower mold;

FIG. 3b is a plan view of one example of the core with slots;

FIG. 4 is a view showing a process of assembling an upper mold and the core;

FIG. 5 is a view showing a state that the assembled mold and the core are inserted into and heated in a heating furnace; and

FIG. 6 is a view showing a process in which the heated mold is placed on a rotary table and centrifugal casting is performed.

### DETAILED DESCRIPTION

Hereinafter, a method for centrifugal casting of a motor rotor in accordance with one embodiment of the present invention will be described with reference to the accompanying drawings.

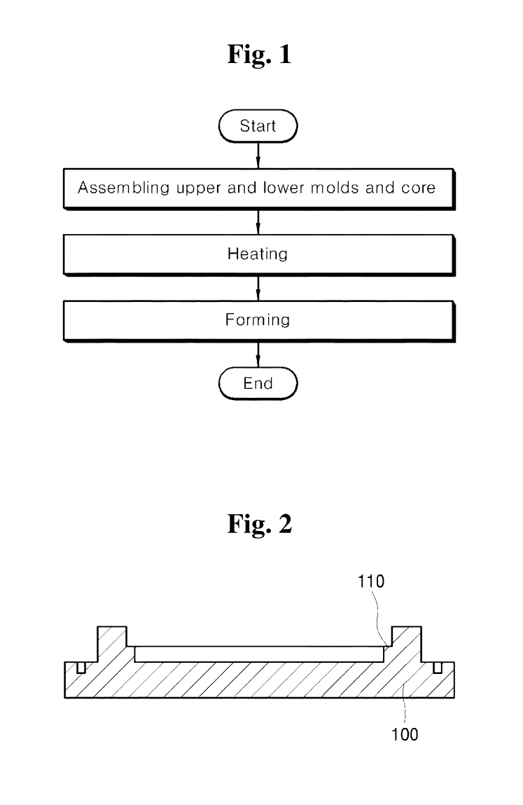

FIG. 1 is a flowchart of a method for centrifugal casting of a motor rotor in accordance with one embodiment of the present invention, and FIG. 2 is a view showing a process of preparing a lower mold in accordance with one embodiment of the present invention.

Referring to FIGS. 1 and 2, the method for centrifugal casting of a motor rotor according to one embodiment of the present invention includes mold/core assembly mold/core heating→forming

Mold/Core Assembly

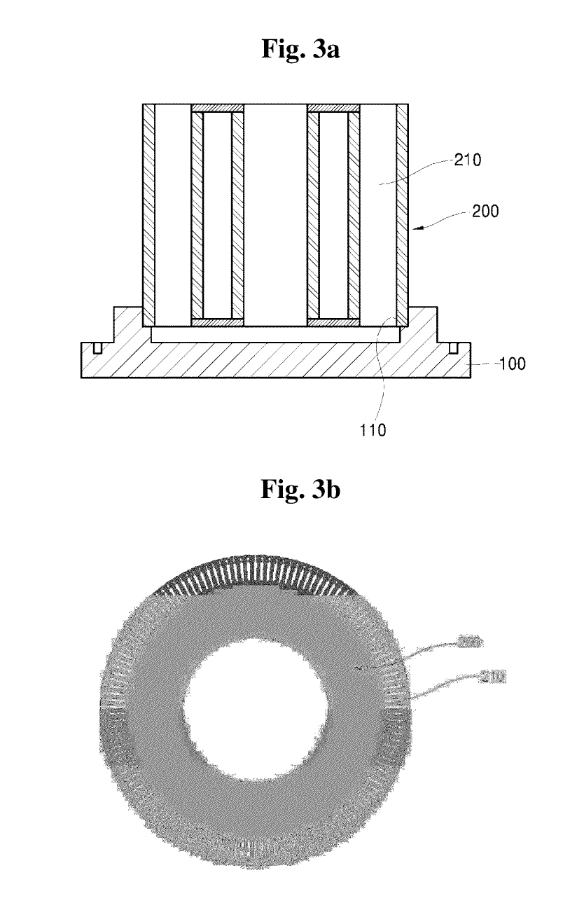

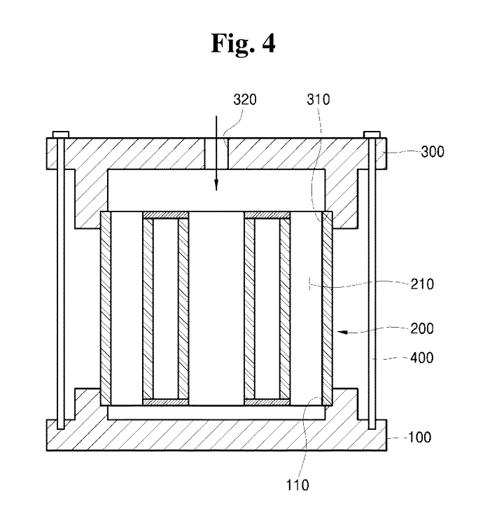

Referring to FIGS. 1 to 4, the mold in accordance with one embodiment of the invention includes a lower mold 100 and an upper mold 300.

A core 200 may be secured to the lower mold 100. That is, a seating platform 110 is formed at an upper central portion of the lower mold 100, and the core 200 is seated on the seating platform 110.

Then, the upper mold 300 is coupled to the lower mold 100.

That is, the upper mold 300 is formed at a lower side thereof with a securing platform 310 to which an upper side of the core 200 is fitted and secured.

In addition, the upper mold 300 is formed with a molten metal injection port 320 through which molten metal is injected into the core 200, for example, into slots 210.

The upper mold 300 and the lower mold 100 are fastened with a plurality of fastening bolts 400 and secured to each other.

Through the molds 100 and 300 with this configuration, a process of preparing the mold will be described.

First, the lower mold 100 is prepared.

Then, the core 200 including silicon steel plates stacked one above another is secured to the upper side of the lower mold 100.

The lower side of the core 200 is seated on and secured to the seating platform 110 formed on the upper side of the lower mold 100 to stand on the seating platform.

Then, the upper mold 300 is placed on the upper side of the core 200.

Here, the securing platform 310 formed on the lower side of the upper mold 300 is fitted into the upper side of the core 200.

Next, the upper mold 300 and the lower mold 100 are fastened to each other using a plurality of fastening bolts 400.

Here, a sleeve (not shown) may be placed on an outer circumference of the core 200 to cover the core 200.

Thus, the upper mold 300, the lower mold 100 and the core 200 are fastened and secured to one another.

As such, the present invention is characterized by previously fastening and securing the upper and lower molds 100 and 300 and the core 200 to one another.

Mold/Core Heating

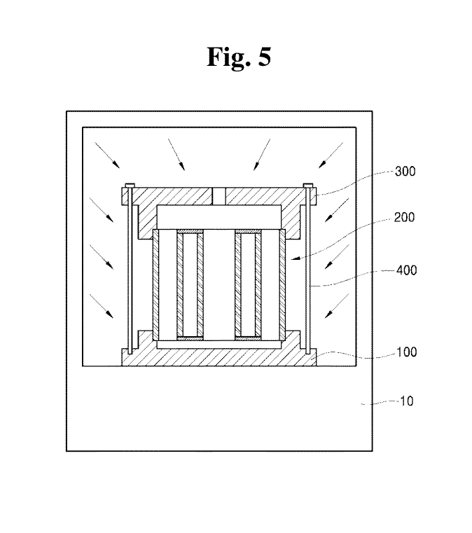

FIG. 5 is a view showing a state that the assembled molds and core are inserted into and heated in a heating furnace.

Referring to FIG. 5, when the upper and lower molds 100, 300 and the core 200 are coupled to one another, that is, after the core 200 is secured to the upper and lower molds 100, 300, the upper and lower molds 100, 300 are gripped by a crane (not shown).

The upper and lower molds 100, 300 gripped by the crane are moved to and inserted into a heating furnace 10.

The heating furnace 10 is a device for heating the upper and lower molds 100, 300 to a preset temperature in response to an external control signal.

Within the heating furnace 10, the upper and lower molds 100, 300 and the core 200 are exposed to an inner atmosphere of the heating furnace 10.

Thus, the heating furnace 10 is used to perform heat treatment of the upper and lower molds 100, 300 and the core 200 at a constant temperature for a preset period of time.

The temperature and time may be determined depending on the kind of core 200.

Through the foregoing process, the molds 100, 300 and the core 200 are subjected to heat treatment at a constant temperature.

In this embodiment, the upper mold 300, the lower mold 100 and the core 200 are assembled and fastened to one another, and then heated to a preset temperature, thereby ensuring operator safety while enhancing workability.

That is, the present invention solves problems of the typical process, for example, burns at high preheating temperature, caused by movement of the molds 100, 300 and the core 200 after being preheated.

Forming

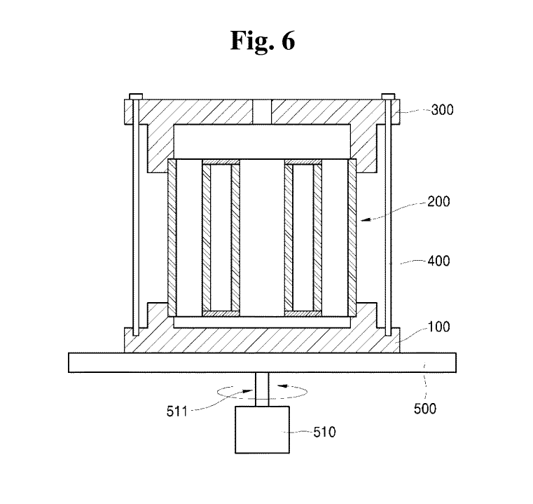

FIG. 6 is a view showing a process in which the heated mold is placed on a rotary table and centrifugal casting is performed.

Referring to FIG. 6, a crane is used to retrieve the upper and lower molds 300, 100 from the heating furnace 10 and to seat the upper and lower molds 300, 100 on a rotary table 500 after the upper and lower molds 300, 100 and the core 200 are assembled to one another and uniformly heated to a preset temperature, as shown in FIG. 5.

The seating state of the molds 100 and 300 coupled to the core 200 may be held by a fastening member 520 provided to the rotary table 500.

Then, molten metal is injected into a forming space between the upper and lower molds 100, 300 through the molten metal injection port 320. The forming space may be communicated with an inner space of the core 200, for example, the slots 210.

The core 200 and the upper and lower molds 100, 300 are uniformly heated and the molten metal is also heated to a predetermined temperature, thereby reducing difference in temperature within a predetermined range.

Thus, the heated molten metal has improved fluidity when injected into the forming space, thereby solving the problem of incomplete forming due to the slots.

In this state, the rotary table 500 is rotated by a rotary motor 510 at a predetermined rotational speed for a predetermined period of time. The rotary motor 510 may be connected to the rotary table 500 through a motor shaft 511, or may transmit power through a belt.

After a predetermined period of time, a rotor formed of the solidified molten metal and including the core 200 is taken out by separating the upper mold 300 and the lower mold 100 and then is subjected to post-processing.

In the post processing, upper and lower end rings formed by solidification of the molten metal injected into the inner space between the upper and lower molds are processed or trimmed.

With the method in accordance with the embodiment of the present invention as described above, the upper mold, the lower mold and the core are preassembled and then heated to perform centrifugal casting, thereby improving fluidity of the molten metal injected into the mold.

In addition, in accordance with the embodiment of the present invention, difference in temperature between the molten metal and the mold/core can be reduced, thereby preventing incomplete forming while enhancing product quality.

Further, in accordance with the embodiment of the present invention, the mold and the core are preassembled and heated, thereby ensuring operator safety while improving workability.

Although some embodiments have been described herein, it should be understood by those skilled in the art that these embodiments are given by way of illustration only, and that various modifications, variations and alterations can be made without departing from the spirit and scope of the invention. Therefore, the scope of the present invention should be defined by the appended claims and equivalents thereof.

What is claimed is:

1. A method for centrifugal casting of a motor rotor, comprising:
assembling molds and a core;
heating the assembled mold and core to a preset temperature; and
forming a motor core by injecting molten metal into a forming space inside the mold and the core while rotating the assembled mold.

2. The method according to claim 1, wherein the mold comprises upper and lower molds, and assembling the mold and the core comprises:
preparing the lower mold;
securing the core to the lower mold; and
assembling the upper mold and the lower mold to form the forming space.

3. The method according to claim 2, wherein the upper mold, the lower mold and the core are uniformly heated to a predetermined temperature after being assembled and secured to each other.

4. The method according to claim 1, wherein forming the motor core comprises:
placing the mold and the core on a rotary table; and
injecting the molten metal through a molten metal injection port formed in the upper mold to communicate with the forming space to fill the forming space inside the mold and the core with the molten metal.
